(19) United States
(12) Patent Application Publication
(10) Pub. No.: US 2009/0181317 A1
(43) Pub. Date: Jul. 16, 2009

(54) TONER FOR DEVELOPING ELECTROSTATIC IMAGE AND PROCESS FOR PRODUCING THE SAME

(75) Inventor: Tohru Moriya, Yaizu-shi (JP)

Correspondence Address: WOOD, HERRON & EVANS, LLP, 2700 CAREW TOWER, 441 VINE STREET, CINCINNATI, OH, 45202, US

(73) Assignee: TOMOEGAWA CO., LTD., Tokyo (JP)

(21) Appl. No.: 11/576,314

(22) PCT Filed: Sep. 29, 2005
(86) PCT No.: PCT/JP05/17933

§ 371 Date: Mar. 29, 2007

(30) Foreign Application Priority Data
Sep. 30, 2004 (JP) 2004-286603
Nov. 30, 2004 (JP) 2004-346142
Mar. 31, 2005 (JP) 2005-100569

(51) Int. Cl. G03G 9/087; G03G 9/00

(52) U.S. Cl. 430/109.4; 430/105; 430/137.2

(57) ABSTRACT

Toner for developing an electrostatic image which hardly causes an offset phenomenon and a wrapping phenomenon and which excels in anti-fusing property, and the production process thereof is provided. The toner for developing an electrostatic image contains at least a binder resin and a colorant, in which the binder resin contains an amorphous resin and a crystalline resin, and an endothermal peak having an onset temperature of a starting point ranging from 100 to 150° C., an onset temperature of an end point ranging from 150 to 200° C., and a half value width ranging from 10 to 40° C. is present in a DSC curve while elevating the temperature measured by a differential scanning calorimeter of the toner. This toner can be produced by performing a heat-melt kneading at the temperature defined as T (° C.) having the range specified by the following formula: (Tₘ−20)≦T≦(Tₘ+30), in which the formula, Tₘ represents the melting point (° C.) of said crystalline resin. And the toner has at least one maximum peak a within a temperature range of 150 to 250° C. and at least one maximum peak β within a temperature range of 50 to 150° C. in the temperature dependency curve of the tangent of the loss angle (tan δ) according to dynamic viscoelasticity measurement.

### TECHNICAL FIELD

The present invention relates to toner for developing an electrostatic image used in electrophotography or electrostatic recording methods and the production method thereof.

### BACKGROUND ART

In general, an image forming apparatus such as a copier or a printer using an electrophotographic method depends on a basic principle which consists of forming a latent image on a photosensitive body having photoconductivity, developing the latent image by electrostatically adhering insulative toners which have acquired friction charges by rubbing carriers or charging members which constitute a part of a developing apparatus to the latent image, transferring the thus formed toner image to a transferring medium such as a plain paper, a film, etc., and then fixing the image onto the transferring media with heating, pressing, using solvent vapor, etc. to form a copied image or a printed image.

In such an image forming apparatus, a heat roller fixation method is generally used as a method for fixing toners because it excels in thermal efficiency, and it enables high-speed fixation to be conducted. This method fixes toners in a fixing apparatus having heated rollers by bringing a transferring media into contact with heated rollers. However, in this method, there is a possibility that a so-called offset phenomenon occurs such that a part of the toners adheres to the surface of heated roller during the fixation, so that the toners are transferred to the transferring media again, thereby spoiling a subsequent image. Moreover, in this method, there is a possibility that a phenomenon of so-called wrapping occurs such that a transferring media winds itself onto the surface of heated roller, thereby causing a jamming of paper. Such a phenomenon likely occurs in the case in which rheology characteristics such as molten viscosity or viscoelasticity of toners which have become molten by the heated roller are not appropriate, and as a result, the releasability is poor. In particular, in the case of forming a full-color image, an image is usually formed by laying four kinds of toners of yellow, magenta, cyan, and black in layers, and hence the thickness of the toner layers will be larger than that of the case of forming a mono-color image. Accordingly, since it becomes likely that an off-set phenomenon or a wrapping phenomenon will be caused, it is necessary to improve the releasability.

So hitherto a method of adding a releasing agent such as a wax into toners has been usually used as a means for preventing such a phenomenon. However, in this method, anti-fusing property of toner is likely to deteriorate and, toners become easily fusible to each of the members of the developing apparatus, thereby possibility preventing formation of a uniform image. Moreover, each of toner particles becomes easily fusible to each other, thereby possibly deteriorating thermal storability of toners. In particular, in a non-magnetic one component developing method, toners are likely to fuse to a charging blade and a developing sleeve. Moreover, in this method, it is not easy to disperse the releasing agent uniformly and finely in a fused resin during the production of toners, and the anti-fusing property is further likely to deteriorate in the case in which dispersibility of the releasing agent is low. Moreover, since it is not easy to select molding conditions such as mixing, thermally melting kneading, extruding, cooling, etc., for improving the dispersibility, the processability is not sufficiently high. Therefore, it is difficult to improve sufficiently the fixing properties such as an off-set phenomenon and a wrapping phenomenon without deteriorating properties of anti-fusing property and thermal storability of toners, by simply adding a molding releasing agent, etc. It should be noted that the processability means the ease of production of toners which excel in compatibility or dispersibility of raw materials.

Japanese Unexamined Patent Application, First Publication No. 2004-151709 has disclosed a resin composition for toners which contains a crystalline polymer having a melting point ranging from 180 to 280° C. and an endotherm ranging from 25 to 150 mJ/mg at the melting point measured using a differential scanning calorimeter (DSC), and an amorphous polyester having a glass transition temperature ranging from 30 to 80° C. According to this document, it is described that the toner prepared from such a resin composition excels in fixing properties and blocking resistance such as low-temperature fixing property, high-temperature off-set resistance, etc. However, since the toner disclosed in this document contains a crystalline polymer having a melting point ranging from 180 to 280° C., there is a problem in that the fixing property may deteriorate in the case in which fusing of toners is not sufficient at the time of fixation. Moreover, there is a problem in that the kneading temperature becomes high during the production of toners and the selective range of molding conditions will decrease, thereby deteriorating the molding property of toners. Accordingly, the compatibility or dispersibility of raw material will deteriorate, thereby deteriorating anti-fusing property.

Moreover, Japanese Unexamined Patent Application, First Publication No. 2004-245887 and Japanese Unexamined Patent Application, First Publication No. 2003-246920 have disclosed toners which contain crystalline polyester as a binder resin.

Moreover, with respect to the production method of toners, Japanese Unexamined Patent Application, First Publication No. 2003-29460 has disclosed conducting melting kneading under the condition where the correlation between the setting temperature of melting kneading Ts and the melting point of a crystalline polyester resin Tm satisfies the formula: (Tm−20)<Ts<(Tm+10).

However, in both documents, the crystalline polyester is one of which the melting point is low, i.e. ranging from 80 to 140° C., and hence it is not possible to prevent the off-set phenomenon and the wrapping phenomenon during the fixation or to obtain excellent anti-fusing property.

Patent document 5 has disclosed the correlation between the minimum value of tan δ at a temperature ranging from 120 to 180° C. and the tan δ value at 180° C. regarding the tan δ of toners. Moreover, Patent document 6 has disclosed toners having the maximum value of tan δ at a temperature ranging from 80 to 100° C. and the minimum value of tan δ at a temperature ranging from 95 to 125° C. However, both documents contain no crystalline resin as a binder resin, and hence it is not possible to prevent the off-set phenomenon and the wrapping phenomenon during the fixation or to obtain excellent anti-fusing property.

Patent document 1: Japanese Unexamined Patent Application, First Publication No. 2004-151709
Patent document 2: Japanese Unexamined Patent Application, First Publication No. 2004-245887
Patent document 3: Japanese Unexamined Patent Application, First Publication No. 2003-246920
Patent document 4: Japanese Unexamined Patent Application, First Publication No. 2003-29460
Patent document 5: Japanese Unexamined Patent Application, First Publication No. 2004-264378
Patent document 6: Japanese Unexamined Patent Application, First Publication No. 2004-151638

### DISCLOSURE OF THE INVENTION

### Problems to be Solved by the Invention

It is an object of the present invention to provide toners for developing an electrostatic image which excel in fixing property, i.e., which hardly cause an off-set phenomenon and a wrapping phenomenon over a wide temperature range in the case of fixing a toner image formed by development onto a transferring media using an ordinal heating roller fixing apparatus.

It is another object of the present invention to provide toners for developing an electrostatic image which excel in both fixing property and anti-fusing property.

Moreover, it is still another object of the present invention to provide toners for developing an electrostatic image which cause no off-set phenomenon and no wrapping phenomenon to a heating roller during the formation of a full-colored image.

Moreover, it is still further another object of the present invention to provide a process for producing toners for developing an electrostatic image, which are capable of solving the above problems.

### Means for Solving the Problems

The inventors of the present invention have thoroughly researched to solve the above problems, and as a result, they have found that a toner having specific thermal property or viscoelasticity, which is obtained by heat-melt kneading a binder resin which contains at least an amorphous resin and a crystalline resin with a colorant and then pulverizing the resultant melt-kneaded product, has a broadened temperature range in which no off-set phenomenon occurs (non-offset temperature region) or a broadened temperature range in which no wrapping phenomenon occurs (non-wrapping temperature region), and that the fusion-resistance of toner is improved and a favorable toner image can be formed, thereby completing the present invention.

That is, the toner for developing an electrostatic image of the present invention is toner for developing an electrostatic image comprising at least a binder resin and a colorant, wherein said binder resin contains an amorphous resin and a crystalline resin, and an endothermal peak having an onset temperature of a starting point ranging from 100 to 150° C., an onset temperature of an end point ranging from 150 to 200° C., and a half value width ranging from 10 to 40° C. is present in a DSC curve while elevating the temperature measured by a differential scanning calorimeter of the toner.

In addition, the toner for developing an electrostatic image of the present invention is the toner for developing an electrostatic image comprising at least a binder resin and a colorant, wherein said binder resin contains an amorphous resin and a crystalline resin, and the toner has at least one maximum peak α within a temperature range of 150 to 250° C. and at least one maximum peak β within a temperature range of 50 to 150° C. in the temperature dependency curve of the tangent of the loss angle (tan δ) according to dynamic viscoelasticity measurement at a temperature ranging from 50 to 250° C.

In the toner for developing an electrostatic image of the present invention, the endothermic quantity of the endothermal peak preferably ranges from 1 to 20 mJ/mg.

In addition, the correlation defined by the following formula (I) is preferably satisfied, provided that the maximum value of tan δ of the maximum peak α present in the temperature range of 150 to 250° C. is represented as αₘₐₓ, and the maximum value of tan δ of the maximum peak β present in the temperature range of 50 to 150° C. is represented as βₘₐₓ, in the temperature dependency curve of the tangent of the loss angle (tan δ).

0.1<αₘₐₓ−βₘₐₓ<1.4 (1)

(in formula (I), αₘₐₓ>βₘₐₓ, 0.8<αₘₐₓ<1.8, 0.4<βₘₐₓ<1.4)

In the toner for developing an electrostatic image of the present invention, the amorphous resin is preferably an amorphous polyester resin, and moreover, the amorphous resin preferably has a glass transition temperature (Tg) ranging from 50 to 80° C.

In the toner for developing an electrostatic image of the present invention, the crystalline resin is preferably a crystalline polyester resin, particularly, polyethyleneterephthalate or polybutyleneterephthalate. In addition, in the crystalline resin, preferably the endothermal peak has an onset temperature of a starting point ranging from 100 to 150° C., an onset temperature of an end point ranging from 170 to 220° C., and a half value width ranging from 10 to 40° C., and the endothermal peak is present in a DSC curve while elevating the temperature measured by a differential scanning calorimeter of the crystalline resin. In addition, preferably the crystalline resin has a melting point of higher than 130° C. and lower than 180° C. And, the crystalline resin is preferably contained in an amount ranging from 1 to 40% by mass of the total amount of the amorphous resin and the crystalline resin in the binder resin.

Furthermore, the toner for developing an electrostatic image of the present invention preferably further contains a releasing agent, and the releasing agent is preferably contained in an amount ranging from 0.1 to 5 parts by mass to 100 parts by mass of the toner.

The toner for developing an electrostatic image of the present invention is suitable for the toner for use in the non-magnetic one component developing method, and is suitable for use in full-colored type.

The process for producing the toner for developing an electrostatic image of the present invention is a process for producing the toner for developing an electrostatic image, comprising at least heat-melt kneading an amorphous resin, a crystalline resin and a colorant to obtain a resin composition, pulverizing and classifying the resultant resin composition, wherein the heat-melt kneading in the step of obtaining said resin composition is performed at the temperature defined as T(° C.) having the range defined by the following formula (1):

(Tₘ−20)≦T≦(Tₘ+30) (1)

(In formula (I), Tₘ represents the melting point (° C.) of said crystalline resin.)

### EFFECT OF THE INVENTION

The toner for developing an electrostatic image of the present invention contains a crystalline resin and has specific thermal properties, i.e. the endothermal peak having an onset temperature of the starting point, an onset temperature of the end point, and a half value width present within the above range, and hence the toner hardly causes an offset phenomenon and a wrapping phenomenon in a broad temperature range while fixing the toner image formed by developing to a transferring medium, in other words, the toner excels in fixing property. In addition, since the toner for developing an electrostatic image of the present invention contains a crystalline resin, resin strength of the binder resin is improved, and the anti-fusing property is also excellent. In addition, since it is possible to reduce the amount of releasing agent, while maintaining a fixing property, the anti-fusing property can be further improved. And, it is suitable for an oilless fixation method, and in addition, it excels in processability during the production. In addition, in accordance with the process for producing the toner for developing an electrostatic image of the present invention, the toner for developing an electrostatic image which excels in fixing property and anti-fusing property can be obtained.

### BRIEF DESCRIPTION OF THE DRAWINGS

FIG. 1 is a drawing which shows a DSC curve during heating of a crystalline polyester resin A used in Example 1.

FIG. 2 is a drawing which shows a temperature dependence curve of the loss tangent (tan δ) in the toner for developing an electrostatic image of the present invention.

FIG. 3 is a drawing which shows a temperature dependence curve of the loss tangent (tan δ) in the toner for developing an electrostatic image of the present invention.

FIG. 4 is a drawing which shows a temperature dependence curve of the loss tangent (tan δ) in the toner for developing an electrostatic image for comparison.

FIG. 5 is a drawing which shows a DSC curve during heating of the toner of Example 1.

FIG. 6 is a drawing which shows a DSC curve during heating of the toner of Comparative Example 1.

### EXPLANATIONS OF THE LETTERS OF NUMERALS

α, β . . . the maximum peak, La . . . a straight line which includes an onset temperature of the starting point Tms and an onset temperature of the end point Tme, Lb . . . a straight line which is perpendicular to the straight line La and passes through the maximum endothermal peak P1, Lc . . . a straight line which is parallel to the straight line La passing through P3, Ll . . . a baseline on a lower temperature side, Lh . . . a baseline on a higher temperature side, P1 . . . the maximum endothermal peak, P2 . . . an intersection of the straight line La and the straight line Lb, P3 . . . the middle point between P1 and P2, P4 . . . an intersection at a lower temperature side, P5 . . . an intersection at a higher temperature side, Tms . . . an onset temperature of the starting point, Tme . . . an onset temperature of the end point, T1 . . . a temperature at the intersection P4, T2 . . . a temperature at the intersection P5.

### BEST MODE FOR CARRYING OUT THE INVENTION

At first, explanation will be given in detail about the components for developing an electrostatic image of the present invention.

### [Binder Resin]

A binder resin used in the toner for developing the electrostatic image of the present invention contains at least an amorphous resin and a crystalline resin. It should be noted that, in the present invention, the crystalline resin means a resin which has a degree of crystallinity of not less than 10%, and of which the endothermal peak due to the fusion of crystal ingredients can be observed clearly in a DSC curve during heating which is measured by a differential scanning calorimeter, on the other hand, the amorphous resin means a resin which has a degree of crystallinity of less than 10%, or a resin of which the endothermal peak due to the fusion of crystal ingredients cannot be observed clearly in a DSC curve during heating which is measured by a differential scanning calorimeter.

### <Amorphous Resin>

As the amorphous resin, all well-known resins for toner can be used, and are not limited in particularly. For example, polyester, styrene (meth)acrylate type copolymer resin, styrene type resins (such as, polystyrene, poly-α-methyl styrene, polychlorostyrene, styrene-propyrene copolymer, styrene-butadiene copolymer, styrene vinylchloride copolymer, styrene vinyl acetate copolymer, styrene maleate copolymer, styrene-acrylonitrile-acrylate copolymer, etc.), (meth)acrylic acid type resin, rosin denaturated maleic acid resin, olefin type resin (for example, α-olefins, such as, polyethylene, polypropylene, etc.), polycarbonate, polyether type resin, (denaturated)polyphenylene ether, vinyl type resin (such as, polyvinyl chloride, polyvinylidene chloride, etc.), urethane type resin, phenolic resin, epoxy type resin, polyphenylene oxide type resin, terpene phenolic resin, poly lactic acid resin, hydrogenated rosin, cyclized rubber, ionomer resin, silicone resin, ketone resin, xylene resin, ABS resin, cycloolefin type copolymer resin, petroleum type resin, hydrogenated petroleum type resin etc. are exemplary. As to the amorphous resin, one kind can be used alone or two or more can be used in combination. In these, polyester, styrene (meth)acrylate type copolymer resin are preferable from a viewpoint that the demand of image properties, durability, productivity of toner, etc. can be satisfied with an excellent balance. Here, (meth)acrylic acid means an acrylic acid and/or a methacrylic acid.

As the amorphous resin used in the toner for full-colored development, an amorphous polyester resin is preferable from the viewpoint of coloring performance, transparency, and resin strength. However, in the case of a polymerizing method toner, styrene (meth) acrylic acid type copolymer resin can also be used.

On the other hand, as the amorphous resin used in the toner for monocolor development, in addition to an amorphous polyester resin, styrene (meth) acrylic acid type copolymer resin can also be used as a preferable one from the viewpoint of versatility, cost, resinous environment characteristic.

### <Amorphous Polyester Resin>

As an amorphous polyester resin suitable for constituting the present invention, those which are derived from the condensation polymerization of an alcohol and a carboxylic acid are exemplary.

As for alcohols, for example, diols such as ethylene glycol, diethylene glycol, triethyleneglycol, 1,2-propylene glycol, 1,3-propylene glycol, 1,3-butylene glycol, 1,4-butane diol, neopentyl glycol, 1,4-butane diol, etc.; 1,4-bis(hydroxymethyl) cyclohexane; etherified bisphenols such as bisphenol A, hydrogenated bisphenol A, polyoxyethylenated bispenol A, polyoxy propylenated bisphenol A, etc.; other bivalent alcohol monomer are exemplary. Each of these alcohols may be used alone or in combination of two or more thereof.

As for carboxylic acids, bivalent organic acids, for example, maleic acid, fumaric acid, mesaconic acid, citraconic acid, itaconic acid, glutaconic acid, phthalic acid, isophthalic acid, terephthalic acid, cyclohexane dicarboxylic acid, succinic acid, adipic acid, sebacic acid, malonic acid, an anhydride and lower alkyl ester of these acids, and dimer of linolenic acid, etc. are exemplary. Each of these carboxylic acids can be used alone or in combination of two or more thereof.

The amorphous polyester is not limited to a polymer derived from a bifunctional monomer only, but may be a polymer which contains ingredients derived from polyfunctional monomers having tri- or more functions.

As for polyhycric alcohol monomers being trihydric or more, which are polyfunctional monomers, for example, polyol monomers more than sorbitol, 1,2,3,6-hexane tetrol, 1,4-sorbitan, pentaerythritol, dipentaerythritol, tripentaerythritol, cane sugar, 1,2,4-butanetriol, 1,2,5 pentane triol, glycerin, 2-methyl propane triol, 2-methyl-1,2,4-butanetriol, trimethylol ethane, trimethylol propane, 1,3,5-tri hydroxymethyl benzene, and other polyhicric alcohol monomers being trihydric or more are exemplary.

As for the trivalent or more polyvalent carboxylic acid monomer, for example, 1,2,4-benzene tricarboxylic acid, 1,2,5-benzene tricarboxylic acid, 1,2,4-cyclohexane tricarboxylic acid, 2,5,7-naphthalene tricarboxylic acid, 1,2,4-naphthalene tricarboxylic acid, 1,2,4-butane tricarboxylic acid, 1,2,5 hexane tricarboxylic acid, 1,3-dicarboxyl-2-methyl-2-methylene carboxy propane, tetra(methylene carboxyl) methane, 1,2,7,8-octane tetra carboxylic acid, enpoltrimer acid and anhydride thereof are exemplary.

The amount of the trifunctional or more polyfunctional monomer used may be suitably selected from the range of 10 to 90 mol, preferably 20 to 80 mol, and more preferably 30 to 80 mol to 100 mol of alcohol or carboxylic acid.

In the present invention, the glass transition temperature (Tg) of the amorphous resin preferably ranges from 50 to 80° C., and more preferably ranges from 55 to 70° C. If the Tg is less than 50° C., then anti-fusing property or thermal storability may deteriorate, whereas if the Tg is higher than 80° C., then fixing strength may deteriorate.

In the present invention, the glass transition temperature (Tg) is defined as follows. A sample of approximately 10 mg is put in a cell made of aluminum, and this cell is placed on a differential scanning calorimeter (made by SEIKO instrument company, model No.: SCC-6200), and a measurement is performed according to JISK7121-1987, while introducing 50 ml of N₂ gas per minute thereinto. First, it is heated at a rate of 10° C. per minute between −20 to 110° C., and then kept at 110° C. for 10 minutes (it is allowed to stand at a temperature not higher than the glass transition temperature (Tg)) so as to remove thermal hysteresis. Next, the temperature is lowered from 110° C. to −20° C. at a rate of 10° C. per minute, and is kept at −20° C. for 10 minutes. Next, a second heating is performed by heating it from −20° C. to 110° C. at a rate of 10° C. per minute, and the glass transition temperature at the midpoint (Tmg) according to the above JIS K 7121-1987, of 9.3 is obtained from the DSC curve observed at this time, thereby determining this temperature to be Tg of the present invention.

### <Crystalline Resin>

In the present invention, the crystalline resin is not particularly limited, as long as it has a degree of crystallinity of not less than 10%, and it has an endothermal peak derived from fusion of crystalline components which can be observed clearly by differential scanning calorimetry (DSC), for example, polyethylene (for example, high density polyethylene, low density polyethylene, ultra high molecular weight polyethylene), polypropylene, polystyrene (for example, isotactic polystyrene, syndiotactic polystyrene), polyamide (for example, nylon 3, nylon 6, nylon 66, nylon 46, nylon 11, nylon 12), polyacetal, polyester (for example, polyethylene terephthalate, polyethylene naphthalate, polybutylene terephthalate, polybutylene naphthalate), poly lactic acid resin, fluorinated resin, etc. are exemplary. Each crystalline resin may be used alone or in combination of two or more thereof. Of these, crystalline polyester and polyamide are preferable, and polyester, i.e. crystalline polyester resin is more preferably used, because of its compatibility with amorphous resin or processability. In the present invention, fixing property at a higher temperature side can be particularly improved by introducing crystalline components into toner.

### <Crystalline Polyester Resin>

As for the crystalline polyester resin, for example, linear polyester resin obtained from condensation polymerization of dialcohol with dicarboxylic acid is exemplary. In addition, in order to add non-linear ingredients and adjust crystallinity or softening point, it is also possible to add polyhydric alcohols being trihydric or more such as glycerin or polyvalent carboxylic acid being trivalent or more such as trimerit acid and perform condensation polymerization.

As for dialcohols, for example, diols such as ethylene glycol, diethylene glycol, triethyleneglycol, 1,2-propylene glycol, 1,3-propylene glycol, 1,3-butylene glycol, 1,4-butanediol, neopentyl glycol, 1,4-butenediol, etc.; 1,4-bis(hydroxymethyl)cyclohexane; etherified bisphenol A such as bisphenol A, hydrogenated bisphenol A, polyoxyethylenated bisphenol A, polyoxy propylenated bispenol A, etc.; and other dihydric alcohol monomers are exemplary. Each of these alcohols may be used alone or in combination of two or thereof.

As for dicarboxylic acids, for example, maleic acid, fumaric acid, mesaconic acid, citraconic acid, itaconic acid, glutaconic acid, phthalic acid, isophthalic acid, terephthalic acid, a naphthalene dicarboxylic acid, cyclohexane dicarboxylic acid, succinic acid, adipic acid, sebacic acid, malonic acid, an anhydride and lower alkyl ester of these acids, a dimer of linolenic acid are exemplary. Each of these carboxylic acid may be used alone or two or more thereof may be used in combination. In view of the provision of crystallinity, terephthalic acid, a naphthalene dicarboxylic acid, anhydrides and lower alkyl ester thereof are preferable.

Polyethylene terephthalate, polyethylene naphthalate, polybutylene terephthalate, polybutylene naphthalate are preferable from the viewpoint of compatibility, dispersibility, versatility, and of these, polybutylene terephthalate which has high crystallinity and a high crystallization rate is particularly preferable. In addition, polyethylene terephthalate is favorably used because the degree of crystallinity and crystallizing rate can be improved by adding a crystalline nucleus agent thereto, although it is inferior to polybutylene terephthalate in degree of crystallinity and crystallizing rate.

In the present invention, the melting point of the crystalline resin preferably exceeds 130° C. and less than 180° C. The melting point is more preferably not less than 140° C. and less than 180° C., still more preferably not less than 150° C. and less than 180° C. If the melting point is not higher than 130° C., then fixing property and anti-fusing property have a tendency to decrease, whereas if the melting point is not less than 180° C., then processability will deteriorate to lower anti-fusing property.

In addition, as for the crystalline resin, in the DSC curve during heating which is measured by a differential scanning calorimeter, an endothermal peak is preferably present, of which an onset temperature of the starting point ranges preferably from 100 to 150° C. (more preferably from 100 to 140° C., still more preferably from 100 to 130° C.), the onset temperature of the end point ranges from 170 to 220° C. (more preferably from 170 to 210° C., and still more preferably from 170 to 200° C.), and the half value width ranges from 10 to 40° C. (more preferably from 10 to 30° C., still more preferably from 15 to 30° C.). If the onset temperature of the starting point, the onset temperature of the end point, or the half value width is out of the above range, then the temperature domain and the temperature width will become inappropriate and the effect of improving fixing property is hardly obtainable. In particular, if the onset temperature of the end point is higher than 220° C., then the fusing of the crystalline components in the toner becomes insufficient, thereby deteriorating fixing properties as well as fixing strength and processability of the toner. If each of the onset temperature of the starting point, onset temperature of the end point, and the half value width is within the above range, then the fixation temperature domain of the toner and the endothermal temperature domain of the crystalline resin will overlap with each other within a specific range, and as a result it becomes possible to improve the fixing property of the toner.

In the present invention, each of the melting point, onset temperature of the starting point, onset temperature of the end point, and half value width is obtained using a DSC curve and defined as follows. The DSC curve used in the present invention is one that is observed during heating when performing a DSC measurement in accordance with ASTM D3418-82 or JIS K7121-1987. As for a concrete measuring method, at first, approximately 10 mg of a sample is put in a cell made of aluminum, and this cell is placed in a differential scanning calorimeter (made by SEIKO instrument company, model No.: SCC-6200) and the measurement is conducted, while blowing N₂ gas at a rate of 50 ml per one minute thereinto. And, the temperature is elevated from 20° C. up to 110° C. at a rate of 10° C. per minute, and then is kept at 110° C. for 10 minutes, thereby removing the thermal hysteresis under the glass transition temperature (Tg) domain of the sample. Next, the temperature is lowered from 110° C. to 20° C. at a rate of 10° C. per minute, and is kept at 20° C. for 10 minutes. Next, the second time elevation of temperature is conducted from 20° C. up to 250° C. at a rate of 10° C. per minute, and in the DSC curve observed at this time the top temperature of the endothermal peak accompanied with the fusion of crystalline components is determined as the melting point, and an offset temperature of the starting point, an offset temperature of the end point, and half value width are obtained from the endothermal peak.

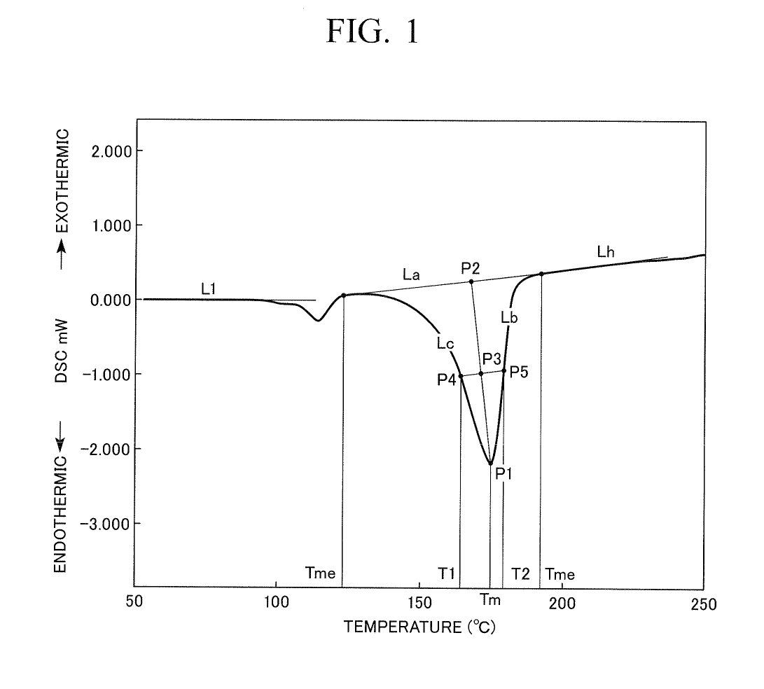

An explanation will be given about the onset temperature of the starting point, onset temperature of the end point, and half value width, referring to FIG. 1. FIG. 1 is a DSC curve during heating the crystalline polyester resin A (polybutylene terephthalate) used in Example 1. In the DSC curve, while regarding a DSC elevation curve in the temperature domain where no endothermal peak is observed as a baseline, the temperature of the point where the baseline at a lower temperature (Ll) is apart from the DSC curve is determined to be the onset temperature (Tms) of the starting point of the present invention, whereas the temperature of the point where the baseline at a higher temperature (Lh) is apart from the DSC curve is determined to be the onset temperature (Tme) of the end point of the present invention. FIG. 1 shows an example in which an endothermal peak having a large endotherm and an endothermal peak having a small endotherm present at a lower temperature side of the peak are observed. In such a DSC curve, the baseline at a lower temperature side (Ll) is hardly determined and hence the onset temperature (Tms) of the starting point is determined to be a displacement point where the DSC curve starts to move toward the endothermic side (downward direction in FIG. 1) in switching from the endothermal peak at a lower temperature side to the endothermal peak at a higher temperature side.

In addition, the half value width will be defined as follows. In FIG. 1, in a straight line (Lb) which is rectangular to a straight line (La) which involves both the onset temperature (Tms) of the starting point and the onset temperature (Tme) of the end point and which passes through the maximum endothermal peak (P1), the middle point between the intersection (P2) with La and the top (P1) of the maximum endothermal peak is determined to be (P3). A straight line (Lc) which passes through the middle point (P2) and is parallel to the straight line (La) is drawn, and intersections between the straight line (Lc) and the DSC curve are determined to be an intersection at a lower temperature side (P4) and an intersection at a higher temperature side (P5), respectively, and the temperature difference (T2−T1) between the temperature (T1) at the intersection (P4) and the temperature (T2) at the intersection (P5) is determined to be a half value width.

In the present invention, the glass transition temperature (Tg) of the crystalline resin is not particularly limited, but in general it can be selected from a range of 10 to 70° C., and preferably ranges from 20 to 60° C., more preferably from 25 to 50° C. If Tg is less than 10° C., then anti-fusing property of the toner is likely to deteriorate, whereas if Tg is higher than 70° C., then each of the onset temperature of the starting point and the onset temperature of the end point tends to increase, and hence fixing strength and processability of the toner are likely to deteriorate. It should be noted that Tg of the crystalline resin can be measured by the above method.

In addition, melt index of the crystalline resin (MI value) is not particularly limited, but it usually ranges from 1 to 100 g/10 min at 235° C., and preferably ranges from 5 to 50 g/10 min in view of compatibility to the amorphous resin and processability. MI value can be measured using a commercially available melt indexer or a flow tester.

In addition, the degree of crystallinity of the crystalline resin is not particularly limited as long as it is not less than 10%, and ranges preferably from 20 to 60%, more preferably from 30 to 40% from the viewpoint of improvement of fixing property or processability. The degree of crystallinity can be increased by using a molding condition or crystalline nucleus agents. The degree of crystallinity can be obtained by X-ray diffraction method.

In the present invention, the crystalline resin is contained in an amount preferably ranging from 1 to 40% by mass, more preferably ranging from 5 to 35% by mass, and still more preferably ranging from 5 to 25% by mass, to the total of the amorphous resin and the crystalline resin in the binder resin. If the crystalline resin is contained in an amount less than 1% by mass, then the content of crystalline components becomes low, deteriorating fixing property, and the resin strength of the binder resin will deteriorate, and hence the anti-fusing property will also deteriorate. If the crystalline resin is contained in an amount higher than 40% by mass, then the crystalline components will be excessive, and hence the toner is hardly melted sufficiently, deteriorating the fixing property at a lower temperature side, and the fixing strength and the processability of the toner will also deteriorate. In addition, since the mechanical strength of the binder resin will increase, the processability such as pulverization of the toner deteriorates so that there is a danger that various kinds of performance such as image quality and electrostatic property will deteriorate. In particular, in full color toner, there is a danger that performances such as color mixing property, color reproducing performance and transparency will deteriorate.

Moreover, the content of the crystalline resin in the toner ranges preferably from 1 to 30% by mass, more preferably from 5 to 25% by mass, particularly preferably from 7 to 23% by mass. If the content of the crystalline resin is less than 1% by mass, then the content of crystalline components will be low, deteriorating fixing property, and since the resin strength of the binder resin will deteriorate, the anti-fusing property is also likely to deteriorate. If the content of the crystalline resin is higher than 30% by mass, then the crystalline components will be excessive, and hence the fusion in fixing the toner will become insufficient, deteriorating fixing strength, and processability will deteriorate, and hence dispersibility of the raw material will deteriorate, and as a result, anti-fusing property will tend to deteriorate. In addition, since the mechanical strength of the binder resin will increase, processability of toner such as pulverization will also deteriorate, so that there is a danger that various kinds of performance such as image quality and electrostatic property will deteriorate. In particular, in full color toner, there is a danger that performances such as color mixing property, color reproducibility and transparency will deteriorate.

Moreover, each of the amorphous resin and the crystalline resin is preferably compatible to the other. As a result of the amorphous resin being compatible to the crystalline resin, the toner which excels in processability and transparency can be obtained, in particular, which can be favorably used in the toner for use in full color. Moreover, since the mechanical strength of the binder resin will increase, the toner which excels in anti-fusing property can be obtained. Here, the compatibility means a state in which each of the amorphous resin and the crystalline resin can be uniformly mixed, and these resins may be either completely compatible or partially compatible.

### <Other Binder Resin Components>

In the present invention, although the binder resin contains at least an amorphous resin and a crystalline resin, the binder resin may contain another resin suitably. The binder resin preferably has moderate viscoelasticity when fusing the toner from the viewpoint of improving the fixing property of the toner, and moreover, it is necessary to give flexibility to the binder resin in the case in which it contains a large amount of hard component such as crystalline resin, from the viewpoint of processability. Accordingly, in such a case, it is preferable to add a thermoplastic elastomer as the other component. By adding a thermoplastic elastomer, it becomes possible to adjust the viscoelasticity during fusing of toner, to improve fixing property and anti-fusing property, and to increase processability when preparing toner.

A thermoplastic elastomer is usually constituted from a hard component which is a hard resin and a soft component which is soft and elastic, for example, olefin type elastomer, styrene type elastomer, vinyl chloride type elastomer, urethane type elastomer, polyamide type elastomer, polyester type elastomer, fluorine type elastomer, silicone type elastomer, isoprene type elastomer, butadiene type elastomer, nitrile butadiene type elastomer, chlorinated polyethylene type elastomer, chloroprene type elastomer are exemplary. Each of these thermoplastic elastomers may be used alone or two or more thereof may be used in combination.

In these thermoplastic elastomers, polyester type elastomer, styrene type elastomer, olefin type elastomer, and polyamide type elastomer can be favorably used from the viewpoint of compatibility, processability, etc. In the case of using an amorphous polyester resin as the amorphous resin, polyester type elastomer can be favorably used. Moreover, in the case of using styrene (meth) acrylic acid type copolymer resin as the amorphous resin, styrene type elastomer can be favorably used.

As for a polyester type elastomer, elastomers of which a soft component is constituted from an aliphatic polyether unit or an aliphatic polyester are exemplary. In the present invention, in the case of using polybutylene telephtalate in the crystalline resin, the hard component of the polyester type elastomer is preferably constituted from a butylene telephtalate unit, from the viewpoint of compatibility, etc. By using such an elastomer, it becomes possible to reform viscoelastic performance by adding softness to the binder resin, or to introduce a crystalline component which is a hard component of the elastomer, while improving processability and processability, thereby obtaining the toner which further excels in fixing property, etc.

The content of the thermoplastic elastomer is preferably not more than 30 parts by mass, more preferably not more than 10 parts by mass to 100 parts by mass of the binder resin. If the content of thermoplastic elastomer is higher than 30 parts by mass, then the viscoelasticity of the toner becomes inappropriate, and hence fixing property will deteriorate, and in addition, there is a possibility that it will be disadvantageous in cost.

As for other binder resins, styrene-(meth)acrylic acid type copolymer resin, styrene type resin, (meth)acrylic acid type resin, olefin type resin (for example, α-olefin resin such as polyethylene, polypropylene, etc.), vinyl type resin (for example, polyvinyl chloride, polyvinylidene chloride, etc.), polyamide type resin, polyether type resin, urethane type resin, epoxy type resin, polyphenylene oxide type resin, terpene phenol resin, poly lactic acid resin, hydrogenated rosin, cyclized rubber, cycloolefin copolymer resin, etc. are exemplary. Each of these may be used alone, or two or more thereof may be used in combination. The content of these binder resin components is usually not more than 10 parts by mass to 100 parts by mass of the binder resin.

### [Colorant]

As for the colorant to be compounded in the toner for developing an electrostatic image of the present invention, pigment for black is exemplary as one for use in black toners, and pigment for magenta, pigment for cyan, and pigment for yellow are exemplary as one for color.

Carbon black is usually exemplary as a pigment for black. Each of the number average particle diameter, oil absorption, and pH of carbon black is not limited particularly. As commercially available products, for example, products made by American Cabot Corp., brand name: Regal 400, 660, 330, 300, SRF-S, STERLING SO, V, NS, and R; products of Colombia Carbon Japan Co., Ltd., bland name: RAVEN H20, MT-P, 410, 420, 430, 450, 500, 760, 780, 1,000, 1,035, 1,060, and 1,080; products Mitsubishi Kagaku Co., Ltd., brand name: # 5B, # 10B, #40, # 2400B, MA-100 are exemplary. Each of these carbon blacks may be used alone or two or more thereof may be used in combination.

The content of carbon black ranges preferably from 0.1 to 20 parts by mass to 100 parts by mass of binder resin, more preferably from 1 to 10 parts by mass, and still more preferably from 1 to 7 parts by mass. If the content of carbon black is too small, then image density will decrease, whereas if the content of carbon black is excessive, then image quality is likely to deteriorate and processability of toner will deteriorate. It should be noted that as a pigment for black, the under-mentioned magnetic powder, for example, iron oxide, magnetite, ferrite, etc. can also be used, in addition to carbon black. As a pigment for magenta, C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209; C.I. pigment violet 19; C.I. Bat red 1, 2, 10, 13, 15, 23, 29, 35 etc. are exemplary. Each of these pigments for magenta may be used alone or two or more thereof may be used in combination.

As a pigment for cyan, C.I. pigment blue 2, 3, 15, 16, 17; Bat blue 6; C.I. Acid blue-45, etc. are exemplary. Each of these pigments for cyan may be used alone or two or more thereof may be used in combination.

As a pigment for yellow, C.I. pigment yellow 1, 2, 3, 4, 5, 6, 7, 10, 11, 12, 13, 14, 15, 16, 17, 23, 65, 73, 74, 83, 93, 94, 97, 155, 180, etc. are exemplary. Each of these pigments for yellow may be used alone or two or more thereof may be used in combination.

As for a pigment for color for use in toner for full-color, from the viewpoint of color mixing property and color reproducibility, C.I. pigment red 57 and 122 are preferably used as a pigment for magenta, C.I. pigment blue 15 is preferably used as a pigment for cyan, and C.I. pigment yellow 17, 93, 155, 180 are preferably used as a pigment for yellow.

The content of the pigment for color usually ranges from 1 to 20 parts by mass to 100 parts by mass of binder resin, preferably from 3 to 20 parts by mass, and more preferably from 4 to 9 parts by mass, particularly preferably from 4.5 to 8 parts by mass. If the content of the pigment for color is smaller than the above range, then image density will decrease, whereas if the content of the pigment for color is excessive, then charging stability will deteriorate and image quality is likely to deteriorate. Moreover, it will be disadvantageous in cost. Moreover, it is also possible to use a so-called master batch, i.e. those in which pigments for color have been previously dispersed at high concentration into the resin which is used as a binder.

### [Releasing Agent]

The toner for developing an electrostatic image of the present invention preferably contains a releasing agent, in order to improve fixing property. Then releasing agent is not particularly limited, as long as it excels in dispersibility to the binder resin, for example, polyolefin type waxes such as polyethylene wax, polypropylene wax, denaturated polyethylene wax, synthesized waxes such as Fischer-Tropsch wax, polyester type synthesized wax, etc.; petroleum type waxes such as paraffin wax, microcrystalline wax, etc.; animal type waxes such as beeswax, whale wax, etc.; plant type waxes such as carnauba wax, candelilla wax, rice wax, etc.; hardened oil such as cured castor oil; mineral type wax such as montan wax, ozocerite, ceresin, etc. are exemplary. Each of these releasing agents may be used alone or two or more thereof may be used in combination. In the present invention, in the case of using an amorphous polyester resin as the binder resin, from the viewpoint of compatibility, it is preferable to use polyester type wax. Polyester type wax involves synthesized wax, one obtained by denaturating montan wax, animal type wax, plant type wax, mineral type wax, etc.

In the present invention, the content of releasing agent ranges from 0.1 to 5 parts by mass to 100 parts by mass of binder resin, preferably from 0.5 to 3 parts by mass, and more preferably from 0.5 to 2 parts by mass. If the content of releasing agent is higher than 5 parts by mass, then anti-fusing property, thermal storability, and processability of the toner may deteriorate. On the other hand, if the content of releasing agent is less than 0.1 parts by mass, then a wrapping phenomenon is likely to occur, and fixing property may deteriorate. Since the toner for developing an electrostatic image of the present invention contains crystalline resin in the binder resin, the toner excels in fixing property and anti-fusing property, and hence it is possible to reduce the content of releasing agent. Accordingly, as a result of the dispersibility of releasing agent to the binder resin being improved, processability of the toner is improved, in addition, it is possible to obtain toner which significantly excels in anti-fusing property, thermal storability, etc., synergistically. In particular, it makes it easy to reconcile fixing property and anti-fusing property in the toner for use in a non-magnetic one component developing method. In addition, it is suitable for full color, because if the content of releasing agent is small, then transparency of the binder resin will not deteriorate.

In the present invention, at least one of the releasing agent has a melting point to be measured by a differential scanning calorimeter ranging preferably from 50 to 120° C., more preferably from 50 to 100° C., and still more preferably from 50 to 85° C. If the melting point of the releasing agent is less than 50° C., then anti-fusing property and thermal storability of the toner may deteriorate, whereas if the melting point of the releasing agent is higher than 120° C., then fixing property and fixing strength of the toner may deteriorate.

Measurement of melting point of the releasing agent is performed as follows, in accordance with ASTM D3418-82. Approximately 10 mg of sample is measured, and is put in a cell made of aluminum, and placed in a differential scanning calorimeter (DSC) (made by SEIKO instrument Co., Ltd., model No.: SCC-6200), and N₂ gas is blown thereinto at a rate of 50 ml per minute. And, the temperature is elevated from 20° C. to 200° C. at a rate of 10° C. per minute, is kept at 200° C. for 10 minutes, and then the temperature is lowered from 200° C. to 20° C. at a rate of 10° C. per minute, and thereafter a second elevation of temperature is conducted under the above condition, and the temperature of the maximum endothermal peak at that time is determined to be the melting point.

### [Other Components]

### <Charge Controlling Agent>

The toner for developing an electrostatic image of the present invention may contain a charge controlling agent, if necessary.

As a charge controlling agent of positive charge, for example, nigrosin and a denaturated one by an aliphatic acid metal salt thereof; quaternary ammonium salts such as tributyl benzyl ammonium-1-hydroxy-4-naphthosulfonate, tetrabutyl ammonium tetrafluoroborate, etc.; diorgano tin oxides such as dibutyl tin oxide, dioctyl tin oxide, dicyclohexyl tin oxide, etc.; diorgano tin borates such as dibutyl tin borate, dioctyl tin borate, dicyclohexyl tin borate, etc.; pyridium salt, azine, triphenylmethane type compound, low molecular weight polymers having a cationic functional group are exemplary. Each of these charge controlling agents of positive charge may be used alone or two or more thereof may be used in combination. In these charge controlling agents of positive charge, nigrosin type compound and quaternary ammonium salt are preferably used.

As charge controlling agents of negative charge, for example, organometallic compounds, such as acetyl acetone metal complex, monoazo metal complex, naphthoic acid or salicylic acid type metal complex or metal salt, chelate compound, low molecular weight polymer having anionic functional group, etc. are exemplary. Each of these charge controlling agents of negative charge may be used alone, or two or more thereof may be used in combination. In these charge controlling agents of negative charge, salicylic acid type metal complex and monoazometal complex are preferably used.

The content of the charge controlling agent usually ranges from 0.1 to 5 parts by mass to 100 parts by mass of binder resin, preferably from 0.5 to 4 parts by mass, and more preferably from 1 to 4 parts by mass. Moreover, the charge controlling agent for use in color toner is preferably colorless or a light color.

### <Magnetic Powder>

The toner for developing an electrostatic image of the present invention may contain magnetic powder, if necessary. As for the magnetic powder, for example, metals such as cobalt, iron, nickel, etc.; alloy of metal such as aluminum, copper, iron, nickel, magnesium, tin, zinc, gold, silver, selenium, titanium, tungsten, zirconium, other metal; metal oxides such as aluminum oxide, iron oxide, nickel oxide, etc.; ferrite, magnetite, etc. are exemplary. The content of the magnetic powder usually ranges from 1 to 70 parts by mass in 100 parts by mass of toner for developing the electrostatic image, a preferably ranges from 5 to 50 parts by mass. As the magnetic powder, those having an average particle diameter ranging from 0.01 to 3 μm are preferably used.

### <Crystalline Nucleus Agent>

The toner for developing an electrostatic image of the present invention may contain a crystalline nucleus agent, because it contains crystalline resin. It becomes possible to accelerate crystallization of the crystalline resin by using a crystalline nucleus agent. Although a crystalline nucleus agent is not limited in particular, for example, metal oxides such as zinc oxide, magnesium oxide, silicon oxide, iron oxide (III), titanium oxide, etc.; inorganic salts such as calcium carbonate, magnesium carbonate, calcium silicate, magnesium silicate, calcium phosphate, magnesium phosphate, calcium sulphate, potassium titanate, etc.; organic acid salts such as calcium oxalate, sodium oxalate, etc.; clay minerals, such as talc, mica, kaolin, etc. are exemplary.

### <Other Additives>

The toner for developing an electrostatic image of the present invention may further contain various kinds of additives, if necessary, such as a stabilizer (for example, ultraviolet ray absorbent, antioxidant, heat stabilizer, etc.), fire retardant, anti-fogging agent, dispersing agent, plasticizer (phthalate ester, fatty acid type plasticizer, phosphoric acid type plasticizer, etc.), polymer antistatic agent, low molecular antistatic agent, compatibilizer, conductive agent, filler, flowability conditioner, etc.

### <External AdditiveExternal Additives>

It is preferable that external additives such as inorganic fine particles or resin fine powder be adhered to the surface of the toner for developing an electrostatic image of the present invention in order to improve flowability or charging stability. As inorganic fine particles, silica, alumina, talc, clay, calcium carbonate, magnesium carbonate, titanium oxide, carbon black powder, magnetic powder, etc. are exemplary. Each of these inorganic fine particles may be used alone, or two or more thereof may be used in combination. Of these inorganic fine particles, silica is particularly preferably used. Silica can be selected suitably depending on use, regardless of an average particle diameter, BET specific surface area, surface treatment, etc. In these, those having a BET specific surface area ranging from 50 to 400 m²/g are preferable, and hydrophobic silica of which the surface is treated is more preferable. In addition to the above inorganic fine particles, a resin fine powder such as poly-4-fluorinated ethylene resin powder, or polyvinylidene fluoride may be adhered to the surface of the toner for developing an electrostatic image of the present invention.

The percentage of inorganic fine particles or resin fine powder added can be suitably selected from the range of 0.01 to 10 parts by mass to 100 parts by mass of the toner for developing an electrostatic image, preferably from 0.1 to 5 parts by mass, more preferably from 0.1 to 4 parts by mass, particularly preferably from 0.3 to 3 parts by mass. If the percentage added is less than 0.01 parts by mass, then the effect on flowability or charging stability of the toner is poor, and a uniform image can hardly be formed, whereas if the percentage is higher than 10 parts by mass, then inorganic fine particles are likely to be isolated and adhered to a photosensitive body or members of a developing apparatus, thereby deteriorating image quality.

### (Thermal Property of the Toner for Developing an Electrostatic Image of the Present Invention)

In the toner for developing an electrostatic image of the present invention, the binder resin contains amorphous resin and crystalline resin, and the toner has specific thermal property, and hence it excels in fixing property and anti-fusing property. That is, the toner for developing an electrostatic image of the present invention necessitates that an endothermal peak having an onset temperature of the starting point ranging from 100 to 150° C. (preferably from 100 to 140° C., and more preferably from 110 to 140° C.), an onset temperature of the end point ranging from 150 to 200° C. (preferably from 150 to 190° C., and more preferably from 160 to 190° C.), and a half value width ranging from 10 to 40° C. (preferably from 10 to 30° C., and more preferably from 15 to 30° C.) be present in the DSC curve while elevating the temperature measured by a differential scanning calorimeter of the toner. It should be noted that this endothermal peak is mainly derived from the crystalline resin, but is not limited thereto.

If the onset temperature of the starting point, the onset temperature of the end point, or the half value width deviates from the above range, then the temperature domain and the temperature range will not be appropriate, and the effect of improving fixing property hardly obtainable. In particular, if the onset temperature of the end point is higher than 200° C., then the fusion of the crystalline component in the toner becomes insufficient, and fixing property will deteriorate and fixing strength and processability of the toner will deteriorate.

Moreover, in the toner for developing an electrostatic image of the present invention, the temperature of the top of the maximum endothermal peak (melting point Tm) ranges preferably from 130 to 190° C., more preferably from 140 to 190° C., and most preferably from 150 to 180° C. If the temperature is less than 130° C., then fixing property or anti-fusing property will tend to decrease, whereas if the temperature is higher than 190° C., then processability will deteriorate and dispersibility will decrease, and hence anti-fusing property will decrease.

The onset temperature of the starting point, onset temperature of the end point and half value width in the toner can be obtained by the above method using the DSC curve measured by the method in accordance with the above method.

The endotherm of the above endothermal peak ranges preferably from 1 to 20 mJ/mg, more preferably from 3 to 20 mJ/mg, most preferably from 4 to 15 mJ/mg (particularly preferably from 5 to 10 mJ/mg). If the endotherm is less than 1 mJ/mg, then the effect of improving fixing property will be hardly obtainable, whereas if the endotherm is higher than 20 mJ/mg, then a larger calory will be necessary for fusing the toner upon being fixed, and hence the fusion of the toner will be insufficient, and as a result, fixing property may deteriorate, or the viscosity will not decrease sufficiently to generate fine unevenness on the surface of the fixed image, thereby brightness of the image may decrease. Moreover, the fact that the endotherm is higher than 20 mJ/mg means that the percentage of the crystalline resin increases, and hence processability or processability such as pulverizing will deteriorate, in addition, various kinds of performance such as image quality performance, charging performance of the toner may deteriorate. Here, the endotherm of the endothermal peak indicates the area of the part surrounded by the above straight line (La) and the DSC curve in the DSC curve measured in accordance with the above method, and the area can be obtained by analyzing software installed in the computer which is attached to the differential scanning calorimeter.

### (Viscoelasticity Performance of Toner for Developing an Electrostatic Image of the Present Invention)

Moreover, the toner for developing an electrostatic image of the present invention preferably has at least one maximum peak α within a temperature range of 150 to 250° C. and at least one maximum peak β within a temperature range of 50 to 150° C. in the temperature dependency curve of the tangent of the loss angle (tan δ) according to dynamic viscoelasticity measurement at a temperature ranging from 50 to 250° C.

Moreover, at least one, preferably 1 or 2 of the maximum peak α is present within the temperature range ranging preferably from 160 to 240° C., more preferably from 170 to 230° C., and particularly preferably from 175 to 215° C., and as for the maximum peak β, at least one, preferably 1 or 2 is present within the temperature range ranging preferably from 60 to 140° C., more preferably from 70 to 130° C., and particularly preferably from 80 to 120° C.

In the present invention, if the maximum peak α is not present within the temperature range of 150 to 250° C., or the maximum peak β is not present in the temperature range of not less than 50° C. and less than 150° C., then a non-wrapping upper limit temperature will decrease and the improvement of fixing property will not be observed, and anti-fusing property will deteriorate.

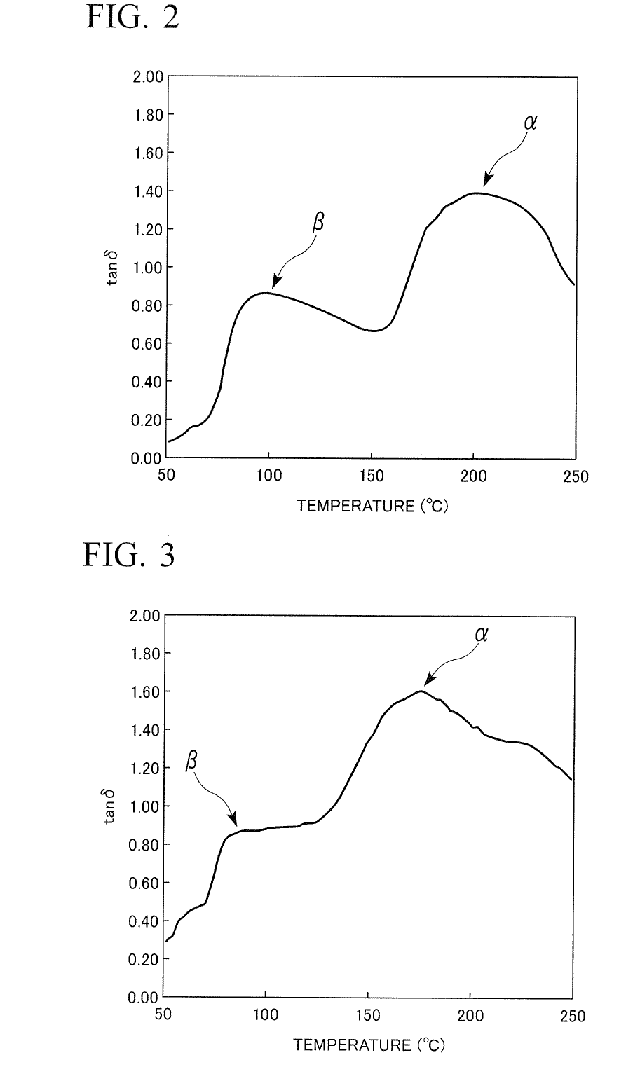

An explanation will be given about “temperature dependency of the loss tangent (tan δ) by the dynamic viscoelasticity measurement at 50 to 250° C.” in the present invention, with referring to drawings. FIGS. 2 and 3 show the temperature dependency curves measured and obtained by the following method for the toner for developing an electrostatic image of the present invention. The temperature dependency curve of FIG. 2 demonstrates that the maximum peak α of tan δ is present at near 200° C. in the temperature range of 150 to 250° C., and that the maximum peak β of tan δ is present at near 100° C. in the temperature range of not less than 50° C. and not more than 150° C.

Moreover, the temperature dependency curve shown in FIG. 3 demonstrates that the maximum peak α of tan δ is present at near 180° C. in the temperature range of 150 to 250° C., and that the maximum peak β exhibits a shoulder at near 85° C. in the temperature range of not less than 50° C. and not more than 150° C., similarly to FIG. 2. It should be noted that the maximum peak in the present invention involves a case of a shoulder shown in FIG. 3.

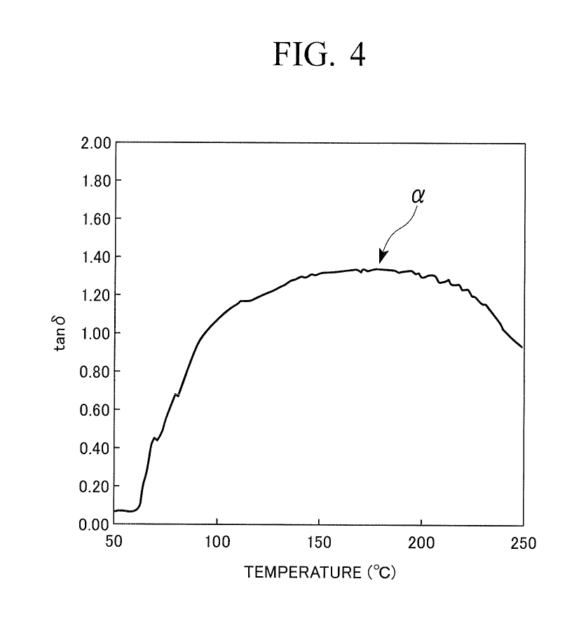

It should be noted that FIG. 4 is for comparison, and FIG. 4 shows the temperature dependency curve on the toner for developing an electrostatic image which is out of scope of the present invention. This figure demonstrates that there is the maximum peak a of tan δ at near 175° C. in the temperature range of 150 to 250° C., but that there is no maximum peak β of tan δ in the range of not less than 50° C. and less than 150° C.

In the present invention, dynamic viscoelasticity performance of toner for developing an electrostatic image is obtained by measuring and analyzing in accordance with the following method.

In other words, the measurement of dynamic viscoelasticity of toner is performed as follows, using a stress rheometer (made by HAAKE Co., Ltd., model name: REOSTRESS RS75). At first, approximately 150 mg of toner is pressed by a force of 400 kg for 60 seconds so as to be shaped into a pellet having a diameter of 20 mm and a thickness ranging from 2 to 3 mm. Next, the resultant toner pellet is set in a probe having a diameter of 20 mm, and the temperature dependency of the dynamic loss tangent (tan δ) within the temperature domain ranging from 50 to 250° C. is measured to obtain an αₘₐₓ value and the temperature thereof and a βₘₐₓ value and the temperature thereof, under the condition of a load of 5N, vibration frequency of 1 Hz, temperature-elevation rate of 3° C./min.

Moreover, when the maximum value of tan δ of the maximum peak in the temperature range of 150 to 250° C. is defined to be αₘₐₓ, and the maximum value of tan δ of the maximum peak in the temperature range of not less than 50° C. and less than 150° C. is defined to be βₘₐₓ, in the temperature dependency curve of the loss tangent (tan δ), the correlation between the αₘₐₓ and the βₘₐₓ is preferably 0.1<αₘₐₓ−βₘₐₓ<1.4 (αₘₐₓ>βₘₐₓ, 0.8<αₘₐₓ<1.8, 0.4<βₘₐₓ<1.4), more preferably 0.2<αₘₐₓ−βₘₐₓ<1.4 (αₘₐₓ>βₘₐₓ, 1.0<αₘₐₓ<1.7, 0.4<βₘₐₓ<1.2), and particularly preferably 0.5<αₘₐₓ−βₘₐₓ<1.4 (αₘₐₓ>βₘₐₓ, 1.2<αₘₐₓ<1.6, 0.4<βₘₐₓ<1.0). As a result of the αₘₐₓ and the βₘₐₓ being in the above correlation, in a fixation temperature domain or in the neighborhood thereof, there is the temperature range where the value of the loss tangent (tan δ) will be the minimum between the maximum peaks α to β, or the temperature range where the value of the loss tangent (tan δ) will be flat, and in such a case, the effect of improving fixing property can be obtained, because the non-wrapping upper limit temperature increases, etc.

Moreover, the toner for developing an electrostatic image of the present invention is not particularly limited in use, regardless of developing method, and the toner can be used for a non-magnetic one component developing method, and a magnetic one component developing method, two-component developing method, and other developing methods. In the magnetic one component developing method, magnetic powder is mixed into the binder resin, and is used as magnetic toner. In the two-component developing method, toner is mixed with carrier and used. Recently, a non-magnetic one component developing method has been favorably received from the viewpoint of the convenience of the apparatus and the cost. And the toner for developing an electrostatic image of the present invention is suitable for the non-magnetic one component developing method, because the toner of the present invention is hardly adhered to each member of the developing apparatus such as a charging blade, a developing sleeve, etc. In addition, the toner for developing an electrostatic image of the present invention is suitable for an oilless fixing method as well as a full color use, because it excels in fixing property.

As a carrier for use in the two-component developing method, for example, nickel, cobalt, iron oxide, ferrite, iron, glass beads can be used. Each of these carriers may be used alone, or two or more thereof may be used in combination. As for a carrier, those having an average particle diameter ranging from 20 to 150 μm are preferable. Moreover, the surface of the carrier may be coated with coatings such as fluorine type resin, acryl type resin, silicone type resin, etc. Moreover, the carrier may be those in which a magnetic material is dispersed in the binder resin.

The toner for developing an electrostatic image of the present invention may be either the toner for mono-color or the toner for full-color, in particular, it can be used preferably as one for use in full-color. In the toner for mono-color, carbon black etc. can be used as a colorant, and in the toner for full-color the above pigment for use in color can be used as a colorant.

Next, a production method of the toner for developing an electrostatic image of the present invention will be explained in detail.

The production method of the toner of the present invention includes the step of heat melt-kneading at least amorphous resin, crystalline resin, and colorant to obtain a resin composition, and the step of pulverizing and classifying the resin composition, in which the temperature T(° C.) of the step of heat melt-kneading in the process of obtaining the resin composition is in the following range specified by the following formula (I).

(Tₘ−20)≦T≦(Tₘ+30) (1)

(in formula (I), Tₘ represents the melting point (° C.) of the binder resin)
The kneading temperature T is preferably in the range specified by the formula:

(Tₘ−10)≦T≦(Tₘ+20).

As the heat melt-kneading method, for example, a method using a twin-screw extruder, a method using a Banbury mixer, a method using a pressing roller, a method using a pressing kneader, etc. are exemplary, but, of these methods, the method using a twin-screw extruder is preferable from the viewpoint of processability and versatility. The resin composition can be obtained by thermally melt-kneading the mixture using a twin-screw extruder, and then extruding the resultant mixture through the die at the tip end of the twin-screw extruder. The kneading temperature of the twin-screw extruder usually ranges from 70 to 250° C., preferably from 70 to 200° C., and more preferably from 90 to 200° C.

In the present invention, in order to increase processability by melting the crystalline resin sufficiently, it is necessary to maintain the kneading temperature within the range of not less than (Tₘ−20)° C., which is lower than the melting point (Tm) of the crystalline resin by 20° C., and not more than (Tₘ+30)° C., which is higher than (Tm) by 30° C. Here, the melting point of the crystalline resin is defined to be the temperature of the top (P1) of the above maximum endothermal peak in the DSC curve measured according to the above method. It should be noted that in the case in which the kneading temperature of the kneader has a range, an average value of the lowest value and the highest value is regarded as the kneading temperature.

Moreover, as a pulverizing method, those using an apparatus such as a hammer mill, a cutter mill, or a jet mill are exemplary. Moreover, as a classifying method, a method using an air-flow classifying apparatus such as a dry-centrifugal classifier is usually exemplary.

The volume average particle diameter of the toner of the present invention thus obtained ranges preferably from 4 to 12 μm, more preferably from 5 to 10 μm, and still more preferably from 6 to 9 μm. The volume average particle diameter means the 50% volume diameter measured using a grain distribution measuring device (Multizizer II, made by Beckman coulters Co., Ltd.).

Moreover, to the surface of the toner, the above inorganic fine particles and resin fine powder may be adhered by mixing using a mixer such as turbine type mixer, Henschel mixer, super mixer, etc.

### EXAMPLES

The present invention will be explained below based on embodiments in detail, but the present invention is not limited by these embodiments. It should be noted that, embodiments, material components, measurement method of physical properties and an evaluation method of toner used in Examples and Comparative Examples are shown below.

### [Components of Toner]

### <Binder Resin>

Amorphous polyester resin
(made by Mitsubishi Rayon Co., Ltd., brand name: FC1142, Tg: 66° C.).
Crystalline polyester resin A (polybutylene terephthalate)
(made by WinTech Polymer Co., Ltd., brand name: Juranecks 400LP, onset temperature of starting point: 122° C., onset temperature of end point: 192° C., half value width: 18° C., Tg: 27° C., melting point: 176° C., MI: 45 g/min).
Crystalline polyester resin B (polybutylene terephthalate)
(made by WinTech Polymer Co., Ltd., brand name: Juranecks 600LP, onset temperature of starting point: 125° C., onset temperature of end point: 189° C., half value width: 16° C., Tg: 27° C., melting point: 174° C., MI: 15 g/min).
Crystalline polyester resin C (polybutylene terephthalate)
(made by WinTech Polymer Co., Ltd., brand name: Juranecks 300FP, onset temperature of starting point: 200° C., onset temperature of end point: 254° C., half value width: 9° C., Tg: 35° C., melting point: 224° C., MI: 73 g/min).
Crystalline polyester resin D (polybutylene terephthalate) (made by Polyplastics Co., Ltd., brand name: Juranecks RSX-10323, melting point: 156° C., Tg: 17° C., MI: 56 g/10 min, onset temperature of starting point: 102° C., onset temperature of end point: 178° C., half value width: 23° C.).

### <Releasing Agent>

Polyester type synthesized wax (made by Nippon Oil & Fats Co., Ltd., brand name: WEP −5, melting point: 84° C.).

### <Colorant>

Cyan pigment for toner: C.I. pigment blue 15:3 (made by Clariant Japan Co., Ltd., brand name: Hostaperm Blue B2G)

### <Charge Controlling Agent>

Zinc salt type charge controlling agent (made by Orient Kagaku Co., Ltd., brand name: BONTRONE −84).

### [Measurement Method of Physical Properties]

### <Differential Scanning Calorimetry of Toner>

The differential scanning calorimetry of the toner was performed as follows, according to ASTM D3418-82 or JIS K7121-1987. At first, approximately 10 mg of toner was put in a cell made of aluminum, the cell was placed in a differential scanning calorimeter (made by SEIKO instrument Co., Ltd., brand name: SCC-6200), and measurement was performed while blowing N₂ gas at a rate of 50 ml per minute thereinto. At first, the temperature was elevated from 20° C. up to 110° C. at a rate of 10° C. per minute, and it was kept at 110° C. for 10 minutes, thereby removing thermal hysteresis of the sample. Next, the temperature was lowered from 110° C. up to 20° C. at a rate of 10° C. per minute, and it was kept at 20° C. for 10 minutes. And thereafter, a second elevation of temperature was performed by elevating the temperature from 20° C. up to 250° C. at a rate of 10° C. per minute, and each of the onset temperature of the starting point, the onset temperature of the end point and the half value width was obtained from the endothermal peak accompanied with the fusion of the sample in the DSC curve formed by the value observed at that time, according to the above method.

### [Evaluation Method of Toner]

### <Fixing Property>

8 parts by mass of the toner and 92 parts by mass of non-coat ferrite carrier (PH-6, made by Powder Tech Co., Ltd.) were mixed to obtain a two-component type developer. Next, using the resultant developer, a belt-like non-fixed image having a size of 3 cm long and 6 cm width was prepared onto an A4 size transfer paper (68 g/m²) through a commercially available copier (made by SHARP Co., Ltd., model: AR-280). The quantity of toner adhesion on the transfer paper was adjusted to be approximately 2.0 mg/cm² by controlling toner density, surface potential of the photosensitive member, developing potential, exposure value, transcription condition, etc. Then, fixation of the above non-fixed image was performed, using an oilless type fixing apparatus in which each of a heat fixation roller, of which the surface layer is made of poly-4-fluorinated ethylene, and a pressure fixation roller, of which the surface layer is made of silicone rubber, rotates double, and adjusting the oilless type fixing apparatus such that the roller pressure became 1 Kgf/cm² and the roller speed became 125 mm/sec, and elevating the temperature of the surface of the heat fixation roller, step by step, at an interval of 10° C., within the range of 150 to 210° C. After the fixation, it was observed to see whether toner dirt would generate or not in the blank space of the transfer paper, and the temperature domain where no dirt would generate was determined to be a non-offset temperature domain. And it was observed whether the transfer paper with a non-fixed image would wrap around the surface of the heat fixation roll or not in the non-offset temperature domain, and the upper limit temperature at a higher temperature side in the temperature domain where no wrapping would occur was confirmed. It should be noted that the upper limit temperature where no practical problem would occur was 190° C.

### <Fixing Strength>

Using the above two-component developer and the above copier, 14 non-fixed patterns, each of which being a circular patch (6 mm (d) and having an image density that changed stepwise within the range of 0.2 to 1.4, were formed on an A4 transfer paper.

And fixation was performed, using the fuser and setting the surface temperature of the heat fixation roller to be 180° C. Then, the image density of the formed fixed image was measured by a reflection density meter (made by Macbeth Co., Ltd. Model: RD-914). And thereafter, a piece cut from a sand eraser was abutted to the fixed image at an angle of 45°, and was rubbed against the image for three strokes under a loading of 1 kg, and then the image density was measured by the same way. Each of the fixing strength was obtained from the image density before and after rubbing each patch through the following formula, and the minimum value thereof was determined to be the fixing strength of the toner.

Fixing strength (%)=(Image density after rubbing/Image density before rubbing)×100

A: Fixing strength is not less than 80%
B: Fixing strength is not less than 70% and less than 80%
C: Fixing strength is less than 70%

### <Anti-Fusing Property>

The toner was put in a developing apparatus of a non-magnetic one component method type ML-2150 printer (made by Samsung Electron Co., Ltd.) and an A4 original copy having a 5% image ratio was copied to 5000 sheets of A4 transfer paper. After 5000 sheets of paper were copied, it was confirmed whether the fusion of toner was observed or not on the charging member (charging blade) by visual observation.

A: No fusion of toner was present.
C: Fusion of toner was present.

### <Processability>

A cross section in the vertical direction to the extruding direction of a board-like extruded product which had been extruded in the twin-screw extruder was observed by an optical microscope (magnifying power: 400) to confirm the dispersibility (degree of dispersion) of each of materials such as binder resin, releasing agent, colorant, etc.

A: Each material had been dispersed uniformly and finely.
B: Although each material had been dispersed uniformly, dispersing diameter of the releasing agent was large.
C: Each material had been dispersed non-uniformly, and dispersing diameter of the releasing agent was large.

### [Overall Evaluation]

From the viewpoint of practical use of the toner, an overall evaluation was performed taking into consideration of the valance between fixing property and anti-fusing property.

A: It excels in both fixing property and anti-fusing property.
B: Any one of fixing property and anti-fusing property is insufficient.
C: It is inferior in both fixing property and anti-fusing property.

### Examples 1-9

### Comparative Examples 1 to 7

As the components of toner, the amorphous polyester resin, the crystalline polyester resin, the releasing agent, the coloring agent, and the charge controlling agent were used in the percentage shown in Tables 1 and 2.

Using a twin-screw kneading extruder (Model: PCM −30, made by Ikegai Co., Ltd.), suitably setting the temperature in each zone within a range of 160 to 200° C. (an average of 180° C. or 175° C.), melt-kneading was performed under the condition of extruding amount of 3.5 kg/hr, and rotation of 250 r.p.m., and as a result, a board-like extruded product having a thickness ranging from 2 to 3 mm was obtained. A cross section of the resultant board-like extruded product was observed to evaluate the processability of each material.

Then, the resultant extruded product was pulverized through a jet mil, and then the resultant product was classified through a dry air flow classifying apparatus to obtain toner particles having a volume average particle size of 8.5 μm. To 100 parts by mass of the resultant toner particles, 1.2 parts by mass of hydrophobic silica (HDKH 13™, made by WACKER CHEMICAL Co., Ltd.) and 0.3 parts by mass of hydrophobic silica (NA-50Y, made by JAPAN AEROSIL Co., Ltd.) were added, and the resultant mixture was agitated and mixed through a Henschel Mixer at a circumferential speed of 40 m/sec for 10 minutes to obtain an external additive toner in which hydrophobic silica had been added to the surface of the toner particle. The resultant toner was subjected to a DSC measurement to obtain the onset temperature of the starting point of the endothermal peak, the onset temperature of the end point, and the half value width thereof. Moreover, dynamic viscoelasticity measurement was performed by the above method to obtain values of the αₘₐₓ, the βₘₐₓ and the temperature thereof from the temperature dependency curve of the loss tangent (tan δ). And thereafter, the fixing property and the anti-fusing property thereof were evaluated, and an overall evaluation was performed based on the evaluation result, taking practical use level of the toner into consideration. Results are shown in Tables 1 and 2.

### [Table 1]

### [Table 2]

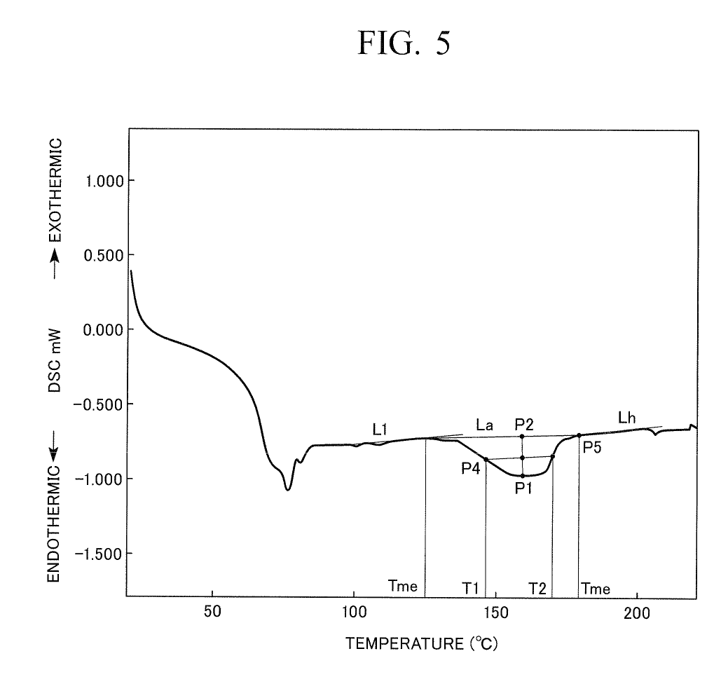

As is clear from Tables 1 and 2, toners of Examples 1 to 9 excel in fixing property, fixing strength, anti-fusing property, and processability and of which overall evaluation were “A”. It should be noted that toner of Example 1 is shown in FIG. 5. As is clear from FIG. 5, endothermal peaks which are derived from the crystalline resin can be observed in the toner.

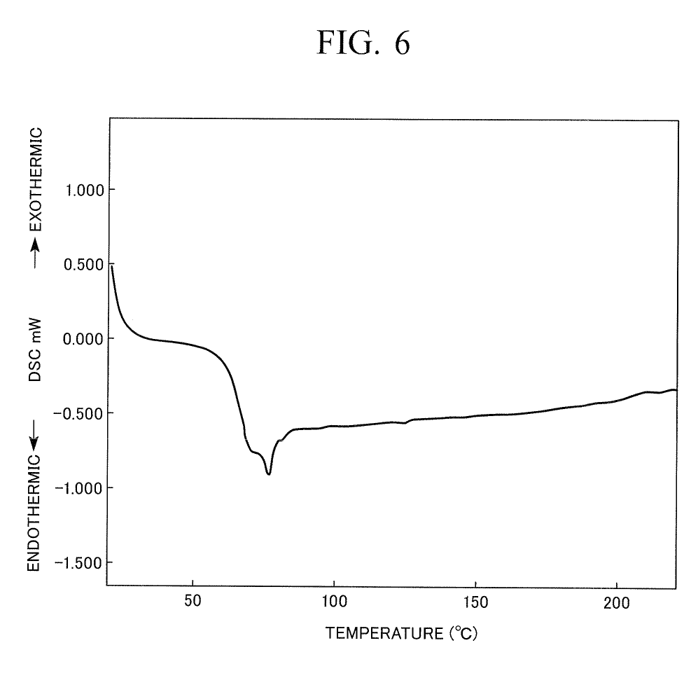

On the other hand, as to toners of Comparative Examples 1 to 7, because each of them lacks any one of the elements of the present invention, it was not possible to be pulverized into toners, or at least one of fixing property and anti-fusing property was insufficient, and hence the overall evaluation was “C”. It should be noted that the DSC curve is shown in FIG. 6. As is clear from FIG. 6, no endothermal peaks derived from the crystalline resin can be observed in the toner.

### INDUSTRIAL APPLICABILITY

Toner for developing an electrostatic image of the present invention excels in fixing property and anti-fusing property, and is suitably applicable to the toner for use in a non-magnetic one component developing method, oilless fixing method, and full-color image formation, particularly.

TABLE 1

| | | | EXAMPLE | EXAMPLE | EXAMPLE | EXAMPLE | EXAMPLE |
|---|---|---|---|---|---|---|---|
| | | UNIT | 1 | 2 | 3 | 4 | 5 |
| COMPOUNDING | AMORPHOUS | MASS % | 83 | 73 | 63 | 81 | 81 |
| OF MATERIAL | POLYESTER RESIN | | | | | | |
| COMPONENTS | CRYSTALLINE | MASS % | 10 | 20 | 30 | 10 | — |
| | POLYESTER RESIN | | | | | | |
| | A: 400LP | | | | | | |
| | CRYSTALLINE | MASS % | — | — | — | — | 10 |
| | POLYESTER RESIN | | | | | | |
| | B: 600LP | | | | | | |
| | CRYSTALLINE | MASS % | — | — | — | — | — |
| | POLYESTER RESIN | | | | | | |
| | C: 300FP | | | | | | |
| | CRYSTALLINE | MASS % | — | — | — | — | — |
| | POLYESTER RESIN | | | | | | |
| | D: RSX | | | | | | |
| | RELEASING AGENT | MASS % | 1 | 1 | 1 | 3 | 3 |
| | COLORANT | MASS % | 4 | 4 | 4 | 4 | 4 |
| | CHARGE | MASS % | 2 | 2 | 2 | 2 | 2 |
| | CONTROLLING AGENT | | | | | | |
| THERMAL | ONSET TEMPERATURE | ° C. | 126 | 127 | 123 | 118 | 125 |
| PROPERTY | OF STARTING POINT | | | | | | |
| OF TONER | ONSET TEMPERATURE | ° C. | 179 | 184 | 183 | 176 | 181 |
| | OF END POINT | | | | | | |
| | HALF VALUE WIDTH | ° C. | 25 | 21 | 17 | 23 | 19 |
| | ENDOTHERM | mJ/mg | 4.1 | 6.8 | 8.3 | 3.9 | 3.8 |
| MAXIMUM PEAK α | TEMPERATURE | ° C. | 203 | 190 | 181 | 204 | 199 |
| OF 150 TO 250° C. | tan δ: αₘₐₓ | — | 1.45 | 1.54 | 1.46 | 1.50 | 1.48 |
| MAXIMUM PEAK β OF | TEMPERATURE | ° C. | 98 | 90 | 85 | 97 | 94 |
| NOT LESS THAN 50° C. | tan δ: βₘₐₓ | — | 0.86 | 0.60 | 0.54 | 0.82 | 0.78 |
| AND LESS THAN 150° C. | | | | | | | |

| | | | | | | |
|---|---|---|---|---|---|---|
| MELTING POINT OF CRYSTALLINE | ° C. | 176 | 176 | 176 | 176 | 174 |
| POLYESTER RESIN | | | | | | |
| KNEADING TEMPERATURE | ° C. | 180 | 180 | 180 | 180 | 180 |
| FIXING PROPERTY | ° C. | 190 | 210 | 210 | 210 | 210 |
| (NON-WRAPPING UPPER LIMIT TEMPERATURE) | | | | | | |
| FIXING STRENGTH | — | A | A | A | A | A |
| ANTI-FUSING PROPERTY | — | A | A | A | A | A |
| PROCESSABILITY | — | A | A | A | A | A |
| (COMPATIBILITY AND DISPERSIBILITY) | | | | | | |
| OVERALL JUDGEMENT (PRACTICABILITY) | — | A | A | A | A | A |

| | | | EXAMPLE | EXAMPLE | EXAMPLE | EXAMPLE |
|---|---|---|---|---|---|---|
| | | UNIT | 6 | 7 | 8 | 9 |
| COMPOUNDING | AMORPHOUS | MASS % | 83 | 73 | 63 | 81 |
| OF MATERIAL | POLYESTER RESIN | | | | | |
| COMPONENTS | CRYSTALLINE | MASS % | — | — | — | — |
| | POLYESTER RESIN | | | | | |
| | A: 400LP | | | | | |
| | CRYSTALLINE | MASS % | — | — | — | — |
| | POLYESTER RESIN | | | | | |
| | B: 600LP | | | | | |
| | CRYSTALLINE | MASS % | — | — | — | — |
| | POLYESTER RESIN | | | | | |
| | C: 300FP | | | | | |
| | CRYSTALLINE | MASS % | 10 | 20 | 30 | 10 |
| | POLYESTER RESIN | | | | | |
| | D: RSX | | | | | |
| | RELEASING AGENT | MASS % | 1 | 1 | 1 | 3 |
| | COLORANT | MASS % | 4 | 4 | 4 | 4 |
| | CHARGE | MASS % | 2 | 2 | 2 | 2 |
| | CONTROLLING AGENT | | | | | |
| THERMAL | ONSET TEMPERATURE | ° C. | 116 | 114 | 116 | 115 |
| PROPERTY | OF STARTING POINT | | | | | |
| OF TONER | ONSET TEMPERATURE | ° C. | 155 | 152 | 152 | 150 |
| | OF END POINT | | | | | |
| | HALF VALUE WIDTH | ° C. | 16 | 14 | 13 | 17 |
| | ENDOTHERM | mJ/mg | 1.4 | 3.2 | 4.6 | 1.6 |
| MAXIMUM PEAK α | TEMPERATURE | ° C. | 197 | 189 | 180 | 199 |
| OF 150 TO 250° C. | tan δ: αₘₐₓ | — | 1.18 | 1.21 | 1.20 | 1.16 |
| MAXIMUM PEAK β OF | TEMPERATURE | ° C. | 108 | 98 | 92 | 109 |
| NOT LESS THAN 50° C. | tan δ: βₘₐₓ | — | 0.90 | 0.64 | 0.58 | 0.93 |
| AND LESS THAN 150° C. | | | | | | |

| | | | | | |
|---|---|---|---|---|---|
| MELTING POINT OF CRYSTALLINE | ° C. | 156 | 156 | 156 | 156 |
| POLYESTER RESIN | | | | | |
| KNEADING TEMPERATURE | ° C. | 175 | 175 | 175 | 175 |
| FIXING PROPERTY | ° C. | 190 | 210 | 210 | 210 |
| (NON-WRAPPING UPPER LIMIT TEMPERATURE) | | | | | |
| FIXING STRENGTH | — | A | A | A | A |
| ANTI-FUSING PROPERTY | — | A | A | A | A |
| PROCESSABILITY | — | A | A | B | B |
| (COMPATIBILITY AND DISPERSIBILITY) | | | | | |
| OVERALL JUDGEMENT (PRACTICABILITY) | — | A | A | A | A |

TABLE 2

| | | | COMPARATIVE | COMPARATIVE | COMPARATIVE | COMPARATIVE |
|---|---|---|---|---|---|---|
| | | UNIT | EXAMPLE 1 | EXAMPLE 2 | EXAMPLE 3 | EXAMPLE 4 |
| COMPOUNDING | AMORPHOUS | MASS % | 93 | 91 | 83 | — |
| OF MATERIAL | POLYESTER RESIN | | | | | |
| COMPONENTS | CRYSTALLINE | MASS % | — | — | — | 93 |
| | POLYESTER RESIN | | | | | |
| | A: 400LP | | | | | |
| | CRYSTALLINE | MASS % | — | — | — | — |
| | POLYESTER RESIN | | | | | |
| | B: 600LP | | | | | |
| | CRYSTALLINE | MASS % | — | — | 10 | — |
| | POLYESTER RESIN | | | | | |
| | C: 300FP | | | | | |
| | CRYSTALLINE | MASS % | | | | |
| | POLYESTER RESIN | | | | | |
| | D: RSX | | | | | |
| | RELEASING AGENT | MASS % | 1 | 3 | 1 | 1 |
| | COLORANT | MASS % | 4 | 4 | 4 | 4 |
| | CHARGE | MASS % | 2 | 2 | 2 | 2 |
| | CONTROLLING AGENT | | | | | |
| THERMAL | ONSET TEMPERATURE | ° C. | NONE | NONE | 202 | —*¹⁾ |
| PROPERTY | OF STARTING POINT | | | | | |
| OF TONER | ONSET TEMPERATURE | ° C. | NONE | NONE | 240 | —*¹⁾ |
| | OF END POINT | | | | | |
| | HALF VALUE WIDTH | ° C. | NONE | NONE | 22 | —*¹⁾ |
| | ENDOTHERM | mJ/mg | NONE | NONE | 7.4 | —*¹⁾ |
| MAXIMUM PEAK α | TEMPERATURE | ° C. | 178 | 176 | 254 | —*¹⁾ |
| OF 150 TO 250° C. | tan δ: αₘₐₓ | — | 1.33 | 1.28 | 1.40 | —*¹⁾ |
| MAXIMUM PEAK β OF | TEMPERATURE | ° C. | NONE | NONE | 100 | —*¹⁾ |
| NOT LESS THAN 50° C. | tan δ: βₘₐₓ | — | NONE | NONE | 0.85 | —*¹⁾ |
| AND LESS THAN 150° C. | | | | | | |

| | | | | | |
|---|---|---|---|---|---|
| MELTING POINT OF CRYSTALLINE | ° C. | NONE | NONE | 224 | 176 |
| POLYESTER RESIN | | | | | |
| KNEADING TEMPERATURE | ° C. | 180 | 180 | 180 | 180 |
| FIXING PROPERTY | ° C. | 150 | 170 | 160 | —*¹⁾ |
| (NON-WRAPPING UPPER LIMIT TEMPERATURE) | | | | | |
| FIXING STRENGTH | | A | A | C | —*¹⁾ |
| ANTI-FUSING PROPERTY | — | C | C | C | —*¹⁾ |
| PROCESSABILITY | — | A | C | C | C |
| (COMPATIBILITY AND DISPERSIBILITY) | | | | | |
| OVERALL JUDGEMENT (PRACTICABILITY) | — | C | C | C | — |

| | | | COMPARATIVE | COMPARATIVE | COMPARATIVE |
|---|---|---|---|---|---|
| | | UNIT | EXAMPLE 5 | EXAMPLE 6 | EXAMPLE 7 |
| COMPOUNDING | AMORPHOUS | MASS % | 90 | 93 | — |
| OF MATERIAL | POLYESTER RESIN | | | | |
| COMPONENTS | CRYSTALLINE | MASS % | — | — | — |
| | POLYESTER RESIN | | | | |
| | A: 400LP | | | | |
| | CRYSTALLINE | MASS % | — | — | — |
| | POLYESTER RESIN | | | | |
| | B: 600LP | | | | |
| | CRYSTALLINE | MASS % | — | — | — |
| | POLYESTER RESIN | | | | |
| | C: 300FP | | | | |
| | CRYSTALLINE | MASS % | — | — | 93 |
| | POLYESTER RESIN | | | | |
| | D: RSX | | | | |
| | RELEASING AGENT | MASS % | 4 | 1 | 1 |
| | COLORANT | MASS % | 4 | 4 | 4 |
| | CHARGE | MASS % | 2 | 2 | 2 |
| | CONTROLLING AGENT | | | | |
| THERMAL | ONSET TEMPERATURE | ° C. | NONE | NONE | —*¹⁾ |
| PROPERTY | OF STARTING POINT | | | | |
| OF TONER | ONSET TEMPERATURE | ° C. | NONE | NONE | —*¹⁾ |
| | OF END POINT | | | | |
| | HALF VALUE WIDTH | ° C. | NONE | NONE | —*¹⁾ |
| | ENDOTHERM | mJ/mg | NONE | NONE | —*¹⁾ |
| MAXIMUM PEAK α | TEMPERATURE | ° C. | 180 | 177 | —*¹⁾ |
| OF 150 TO 250° C. | tan δ: αₘₐₓ | — | 1.30 | 1.34 | —*¹⁾ |
| MAXIMUM PEAK β OF | TEMPERATURE | ° C. | NONE | NONE | —*¹⁾ |
| NOT LESS THAN 50° C. | tan δ: βₘₐₓ | — | NONE | NONE | —*¹⁾ |
| AND LESS THAN 150° C. | | | | | |

| | | | | |
|---|---|---|---|---|
| MELTING POINT OF CRYSTALLINE | ° C. | NONE | NONE | 156 |
| POLYESTER RESIN | | | | |
| KNEADING TEMPERATURE | ° C. | 180 | 175 | 175 |
| FIXING PROPERTY | ° C. | 180 | 150 | —*¹⁾ |
| (NON-WRAPPING UPPER LIMIT TEMPERATURE) | | | | |
| FIXING STRENGTH | | A | A | —*¹⁾ |
| ANTI-FUSING PROPERTY | — | C | C | —*¹⁾ |
| PROCESSABILITY | — | C | A | C |
| (COMPATIBILITY AND DISPERSIBILITY) | | | | |
| OVERALL JUDGEMENT (PRACTICABILITY) | — | C | C | — |

*¹⁾SINCE THE SAMPLE WAS NOT PULVERIZED AND COULD NOT BE CONVERTED INTO TONERS, MEASUREMENT WAS NOT PERFORMED.

1. A toner for developing an electrostatic image comprising at least a binder resin and a colorant, wherein said binder resin contains an amorphous resin and a crystalline resin, and an endothermal peak having an onset temperature of a starting point ranging from 100 to 150° C., an onset temperature of an end point ranging from 150 to 200° C., and a half value width ranging from 10 to 40° C. is present in a DSC curve while elevating the temperature measured by a differential scanning calorimeter of said toner.

2. The toner for developing an electrostatic image as set forth in claim 1, wherein an endotherm of said endothermal peak ranges from 1 to 20 mJ/mg.

3. The toner for developing an electrostatic image as set forth in claim 1, wherein said endothermal peak has the onset temperature of the starting point ranging from 100 to 150° C., an onset temperature of the end point ranging from 170 to 220° C., and the half value width ranging from 10 to 40° C., and said endothermal peak is present in the DSC curve while elevating the temperature measured by a differential scanning calorimeter of said crystalline resin.

4. A toner for developing an electrostatic image comprising at least a binder resin and a colorant, wherein said binder resin contains an amorphous resin and a crystalline resin, and said toner has at least one maximum peak α within a temperature range of 150 to 250° C. and at least one maximum peak β within a temperature range of 50 to 150° C. in the temperature dependency curve of a tangent of loss angle (tan δ) according to dynamic viscoelasticity measurement at a temperature ranging from 50 to 250° C.

5. The toner for developing an electrostatic image as set forth in claim 4, wherein a correlation defined by the following formula (I) is satisfied, provided that the maximum value of tan δ of the maximum peak α present in the temperature range of 150 to 250° C. is represented as αₘₐₓ, and the maximum value of tan δ of the maximum peak β present in the temperature range of 50 to 150° C. is represented as βₘₐₓ, in the temperature dependency curve of the tangent of the loss angle (tan δ).
0.1<αₘₐₓ−βₘₐₓ<1.4 (1)
(in formula (I), αₘₐₓ>βₘₐₓ, 0.8<αₘₐₓ<1.8, 0.4<βₘₐₓ<1.4)

6. The toner for developing an electrostatic image as set forth in claim 1 or 4, wherein said amorphous resin is an amorphous polyester resin.

7. The toner for developing an electrostatic image as set forth in claim 1 or 4, wherein said crystalline resin is a crystalline polyester resin.

8. The toner for developing an electrostatic image as set forth in claim 7, wherein said crystalline resin is polyethyleneterephthalate or polybutyleneterephthalate.

9. The toner for developing an electrostatic image as set forth in claim 1 or 4, wherein said crystalline resin is contained in an amount ranging from 1 to 40% by mass of the total amount of the amorphous resin and the crystalline resin in said binder resin.

10. The toner for developing an electrostatic image as set forth in claim 1 or 4, wherein said amorphous resin has a glass transition temperature (Tg) ranging from 50 to 80° C.

11. The toner for developing an electrostatic image as set forth in claim 1 or 4, wherein said crystalline resin has a melting point of higher than 130° C. and lower than 180° C.

12. The toner for developing an electrostatic image as set forth in claim 1 or 4, wherein said crystalline resin is contained in an amount ranging from 1 to 30% by mass.

13. The toner for developing an electrostatic image as set forth in claim 1 or 4, further comprising a releasing agent.

14. The toner for developing an electrostatic image as set forth in claim 13, wherein said releasing agent is contained in an amount ranging from 0.1 to 5 parts by mass to 100 parts by mass of said toner.

15. The toner for developing an electrostatic image as set forth in claim 1 or 4, wherein said toner is one which is for use in a non-magnetic one component developing method.

16. The toner for developing an electrostatic image as set forth in claim 1 or 4, wherein said toner is one which is for use in full-colored type.

17. A process for producing the toner for developing an electrostatic image as set forth in claim 1 or 4, comprising at least heat-melt kneading an amorphous resin, a crystalline resin and a colorant to obtain a resin composition, and pulverizing and classifying the resultant resin composition, wherein said heat-melt kneading in said step for obtaining said resin composition is performed at the temperature defined as T(° C.) having the range defined by the following formula (1):
(Tₘ−20)≦T≦(Tₘ+30) (1)
(In formula (I), Tₘ represents the melting point (° C.) of said crystalline resin.)
